(19) United States
(12) Patent Application Publication
(10) Pub. No.: US 2024/0424920 A1
(43) Pub. Date: Dec. 26, 2024

(54) COIL UNIT

(71) Applicant: HONDA MOTOR CO., LTD., Tokyo (JP)

(72) Inventor: Jin Katsuya, Wako-shi (JP)

(21) Appl. No.: 18/679,501

(22) Filed: May 31, 2024

(30) Foreign Application Priority Data
Jun. 26, 2023 (JP) 2023-104444

(51) Int. Cl. B60L 53/12; H02J 50/00; H02J 50/12

(52) U.S. Cl. CPC B60L 53/12; H02J 50/005; H02J 50/12

(57) ABSTRACT

A vehicle coil unit includes: a housing; a coil that receives AC electric power transmitted in a contactless manner from an electric power transmission apparatus; and a support member. The housing has a front surface exposed to the outside below a vehicle body. The coil that is arranged within the housing is in direct contact with the housing via a heat release member provided on an inner surface of the housing. The support member is in contact with the inner surface of the housing and the heat release member and covers a surface of the coil. A width of the support member in an orthogonal direction to a protrusion direction of the heat release member changes in an increasing tendency toward the inner surface from a front end side of the heat release member along the protrusion direction.

### CROSS-REFERENCE TO RELATED APPLICATION

Priority is claimed on Japanese Patent Application No. 2023-104444, filed on Jun. 26, 2023, the contents of which are incorporated herein by reference.

### BACKGROUND

### Field of the Invention

The present invention relates to a coil unit.

Background

In recent years, in order to ensure that more people have access to affordable, reliable, sustainable, and advanced energy, research and development relating to charging and electric power supply in a vehicle on which a secondary battery is mounted, which contributes to energy efficiency, has been conducted.

In the related art, in a contactless electric power transmission system that supplies electric power to a vehicle from the outside of the vehicle by contactless electric power transmission, a device is known which ensures mechanical strength and heat release properties by covering an electric power transmission coil and an electric power reception coil by a thermally conductive resin (for example, refer to Japanese Unexamined Patent Application, First Publication No. 2008-87733).

### SUMMARY

In techniques relating to charging and electric power supply in a vehicle on which a secondary battery is mounted, it is desired to prevent an increase in weight while ensuring cooling of a coil unit on the vehicle side. In a contactless electric power supply device of the related art described above, for example, without requiring a configuration that causes a weight increase such as a cooling device, it is desired to reduce thermal resistance of a housing with respect to a coil, a heat generation component, and the like and improve cooling efficiency.

An aspect of the present invention aims to provide a coil unit capable of improving cooling efficiency while preventing an increase in weight. Further, the aspect of the present invention contributes to energy efficiency.

A coil unit according to a first aspect of the present invention includes: a housing having a front surface exposed to the outside below a vehicle body; a heat release member that protrudes to the inside from an inner surface on the rear side with respect to the front surface of the housing; a coil that is arranged within the housing and receives AC electric power transmitted in a contactless manner from an electric power transmission apparatus; and a support member that is in contact with the inner surface of the housing and the heat release member and covers at least part of a surface of the coil, wherein a width of the support member in an orthogonal direction to a protrusion direction of the heat release member changes in an increasing tendency toward the inner surface from a front end side of the heat release member along the protrusion direction.

A second aspect is the coil unit according to the first aspect described above, wherein the support member may be formed of a material having predetermined electrical insulation properties and predetermined thermal conductivity.

A third aspect is the coil unit according to the second aspect described above, wherein a thickness of the support member that covers a front end surface of the coil in the protrusion direction may be set in accordance with the electrical insulation properties, and a thickness of the support member that covers a surface on an opposite side of the heat release member side with respect to the coil in the orthogonal direction may be set in accordance with the thermal conductivity.

A fourth aspect is the coil unit according to any one of the first to third aspects described above, wherein the housing may include the front surface in which a groove along a flow direction of wind received at the time of traveling is formed.

According to the first aspect described above, the width of the support member changes in an increasing tendency toward the inner surface of the housing from the front end side of the heat release member along the protrusion direction, and thereby, it is possible to increase a heat transfer amount on the inner surface side and improve cooling efficiency. It is possible to prevent an increase in weight and volume of the support member, for example, compared to the case where the width of the support member is constant along the protrusion direction.

In the case of the second aspect described above, it is possible to ensure a desired withstand voltage and desired heat release properties by the support member having the predetermined electrical insulation properties and the predetermined thermal conductivity with respect to the coil that generates heat.

In the case of the third aspect described above, it is possible to ensure a desired withstand voltage and desired heat release properties while preventing the increase in the weight and the volume of the support member.

In the case of the fourth aspect described above, it is possible to cool the coil from the front surface of the housing by the groove that efficiently guides travel wind at the time of traveling of the vehicle. The coil is in contact with the housing via the support member and thereby reduces thermal resistance, and it is possible to improve the cooling efficiency.

### BRIEF DESCRIPTION OF THE DRAWINGS

FIG. 1 is an exploded perspective view showing a configuration of a coil unit in an embodiment of the present invention.

FIG. 2 is a cross-sectional view of the coil unit in the embodiment of the present invention cut along a Z-X plane at a position of an A-A line shown in FIG. 1.

FIG. 3 is an enlarged view showing a coil and a housing in the coil unit of the embodiment of the present invention.

FIG. 4 is a view showing a process of integrating the coil and the housing in the coil unit of the embodiment of the present invention.

### DESCRIPTION OF EMBODIMENTS

Hereinafter, a coil unit according to an embodiment of the present invention will be described with reference to the attached drawings.

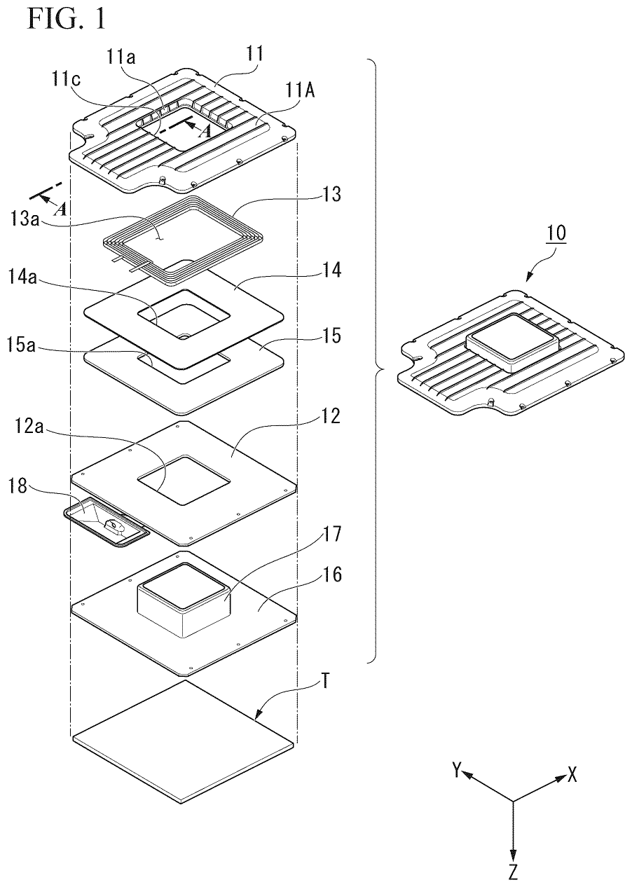

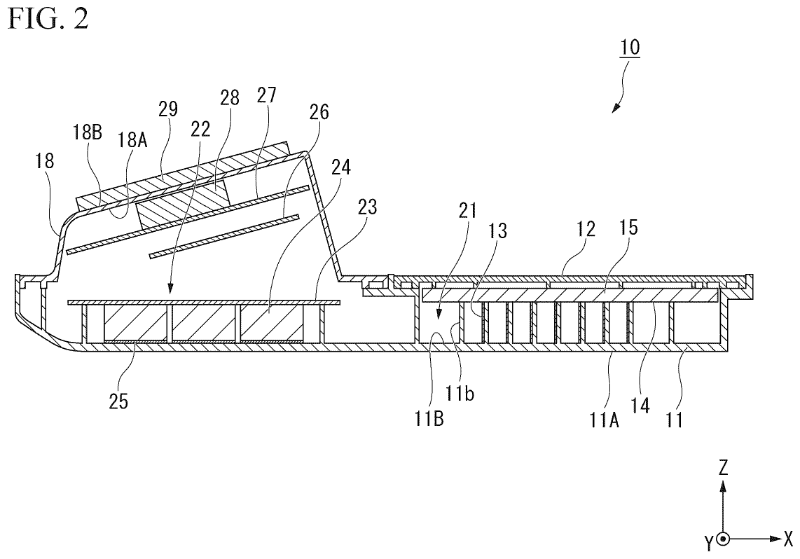

FIG. 1 is an exploded perspective view showing a configuration of a coil unit 10 in an embodiment. FIG. 2 is a cross-sectional view of the coil unit 10 in the embodiment cut along a Z-X plane at a position of an A-A line shown in FIG. 1.

Hereinafter, each axis direction of the X-axis, the Y-axis, and the Z-axis orthogonal to one another in a three-dimensional space is a direction parallel to each axis. For example, as shown in FIG. 1 and FIG. 2, the Z-axis direction is parallel to an upward-downward direction of a movable body such as a vehicle on which the coil unit 10 is mounted, the X-axis direction is parallel to a forward-rearward direction of the movable body, and the Y-axis direction is parallel to a rightward-leftward direction of the movable body. For example, a positive direction of the Z-axis is an upward direction of the movable body, a positive direction of the X-axis is a forward direction of the movable body, and a positive direction of the Y-axis is a right direction of the movable body.

The coil unit 10 of the embodiment is mounted, for example, on a vehicle which receives electric power from the outside by contactless electric power transmission. The vehicle is, for example, an electric vehicle such as an electric automobile, a hybrid vehicle, and a fuel cell vehicle. The coil unit 10 is fixed, for example, to a lower portion of a sub-frame that has a frame shape and is provided on a lower portion of a vehicle body. The coil unit 10 constitutes part of an electric power reception apparatus that receives AC electric power from an external electric power transmission apparatus T by contactless electric power transmission.

As shown in FIG. 1 and FIG. 2, the coil unit 10 includes, for example, a housing 11, a first cover 12, a coil 13, an insulation member 14, a core member 15, a back member 16, an inner member 17, and a second cover 18.

An outer shape of the housing 11 is formed, for example, in a rectangular frame shape. The housing 11 is formed of, for example, a material such as a resin having predetermined thermal conductivity. The housing 11 includes, for example, a first accommodation portion 21 and a second accommodation portion 22. The coil 13, the insulation member 14, and the core member 15 described later are arranged in the first accommodation portion 21. Boards 23, 26, 27, a capacitor 24, and a semiconductor element 28 described later are arranged in the second accommodation portion 22. The first accommodation portion 21 is provided, for example, so as to surround a lower side in an upward-downward direction, and an inner side and an outer side in a direction orthogonal to the upward-downward direction of the coil 13, the insulation member 14, and the core member 15 described later. The second accommodation portion 22 is provided, for example, on a further rearward side than the first accommodation portion 21 in a forward-rearward direction. The second accommodation portion 22 is provided, for example, so as to surround a lower side in the upward-downward direction, and an outer side in the direction orthogonal to the upward-downward direction of the boards 23, 26, 27, the capacitor 24, and the semiconductor element 28 described later.

The housing 11 includes a front surface 11A, for example, on which a plurality of grooves 11a are formed. The front surface (that is, a lower surface on the lower side in the upward-downward direction) 11A of the housing 11 is exposed to the outside below the vehicle body.

The plurality of grooves 11a are formed, for example, along the forward-rearward direction along a flow direction of wind (travel wind) received at the time of traveling of the vehicle.

The housing 11 includes, for example, a plurality of heat release members 11b that protrude to the inside from an inner surface 11B on the rear side with respect to the front surface 11A. An outer shape of the heat release member 11b is, for example, a fin having a plate shape. The plurality of heat release members 11b are in contact with the coil 13.

An outer shape of the first cover 12 is formed, for example, in a rectangular plate shape in which a penetration hole 12a is formed in a thickness direction. The first cover 12 is provided, for example, so as to surround an upper side in the upward-downward direction of the coil 13, the insulation member 14, and the core member 15 described later. The first cover 12 forms an accommodation space in which the coil 13, the insulation member 14, and the core member 15 are accommodated between the first cover 12 and the inner surface 11B of the housing 11. The first cover 12 closes an open end of the first accommodation portion 21 of the housing 11 in which the coil 13, the insulation member 14, and the core member 15 are accommodated.

An outer shape of the coil 13 is formed, for example, in a rectangular spiral shape along the inner surface 11B of the housing 11. The coil 13 is arranged, for example, on an upper side of the inner surface 11B. A strand of the coil 13 is in direct contact with the plurality of heat release members 11b.

An outer shape of the insulation member 14 is formed, for example, in a rectangular sheet shape in which a penetration hole 14a is formed in the thickness direction. The insulation member 14 is formed of a material having electrical insulation properties. The insulation member 14 is arranged, for example, on an upper side of the coil 13.

An outer shape of the core member 15 is formed, for example, in a rectangular plate shape in which a penetration hole 15a is formed in the thickness direction. The core member 15 is formed of, for example, a magnetic material having relatively large permeability such as a non-directional (isotropic) magnetic material such as a ferrite, or a directional (anisotropic) magnetic material of an electromagnetic steel sheet such as a silicon steel sheet or a soft magnetic material such as a nanocrystalline soft magnetic material. The core member 15 is arranged, for example, on an upper side of the insulation member 14.

An outer shape of the back member 16 is formed, for example, in a rectangular plate shape in which a penetration hole is formed in the thickness direction. An outer shape of the inner member 17 is formed, for example, in a box shape that includes a wall portion having a rectangular frame shape and a lid portion that closes a lower open end of the wall portion. The inner member 17 protrudes, for example, downward in the upward-downward direction from a circumferential edge portion that surrounds the penetration hole of the back member 16. The back member 16 and the inner member 17 are integrally formed of, for example, a magnetic material having relatively large permeability such as an electromagnetic steel sheet such as a silicon steel sheet.

The back member 16 is arranged, for example, on an upper side in the upward-downward direction of the first cover 12.

The inner member 17 is inserted, for example, in the penetration holes 12a, 15a, 14a of the first cover 12, the core member 15, and the insulation member 14, respectively, an empty core region 13a of the coil 13, and a penetration hole 11c in the thickness direction of the housing 11. The inner member 17 protrudes, for example, downward from the front surface 11A of the housing 11.

An outer shape of the second cover 18 is formed, for example, in a hipped roof shape. The second cover 18 forms an accommodation space in which the boards 23, 26, 27, the capacitor 24, and the semiconductor element 28 are accommodated between the second cover 18 and the inner surface 11B of the housing 11. The second cover 18 closes an open end of the second accommodation portion 22 of the housing 11 in which the boards 23, 26, 27, the capacitor 24, and the semiconductor element 28 are accommodated.

The board 23 (capacitor board) fixes, for example, a plurality of capacitors 24 such as a film capacitor. The capacitor 24 is, for example, a resonant capacitor (condenser) or the like connected to the coil 13. The plurality of capacitors 24 are fixed to the capacitor board 23 and are in contact with the inner surface 11B of the housing 11, for example, via a thermally conductive material 25 such as a thermal compound.

The control board 26 is arranged, for example, above the capacitor board 23. The control board 26 controls, for example, electric power conversion of the electric power reception apparatus and communication with the external electric power transmission apparatus T. The board 26 (control board) is a software function unit that functions by a predetermined program being executed by a processor such as a CPU (Central Processing Unit). The software function unit is an ECU (Electronic Control Unit) that includes the processor such as a CPU, a ROM (Read-Only Memory) that stores the program, a RAM (Random-Access Memory) that temporarily stores data, and an electronic circuit such as a timer. At least part of the control board 26 may be an integrated circuit such as a LSI (Large-Scale Integration).

The control board 26 generates, for example, a control signal input to the board 27 (gate drive board) in accordance with a target output or the like of the electric power reception apparatus. The control signal is, for example, a signal indicating a timing of an ON (conduction)/OFF (cutoff) drive of a plurality of switching elements that constitute an electric power conversion portion of the electric power reception apparatus. For example, the control signal is a pulse-width modulated signal or the like.

The gate drive board 27 is arranged, for example, above the control board 26. The gate drive board 27 is connected, for example, to a gate of the plurality of switching elements that constitute the electric power conversion portion of the electric power reception apparatus. The gate drive board 27 includes, for example, an integrated circuit, a plurality of gate resistances, and the like.

The gate drive board 27 generates a gate signal for actually performing an ON (conduction)/OFF (cutoff) drive of each switching element on the basis of the control signal received from the control board 26.

For example, the gate drive board 27 performs amplification, level shift, and the like of the control signal and generates a gate signal.

The semiconductor element 28 is, for example, a switching element, a rectifier element, and the like that constitute the electric power conversion portion of the electric power reception apparatus. The switching element is, for example, a transistor such as a SiC (Silicon Carbide) MOSFET (Metal-Oxide-Semiconductor Field-Effect Transistor). The rectifier element is, for example, a reflux diode connected in parallel to each transistor. The plurality of semiconductor elements 28 are fixed, for example, to an upper portion of the gate drive board 27 and are arranged between the gate drive board 27 and an inner surface 18A of the second cover 18.

The second cover 18 includes a heat radiator 29 that is arranged on an outer surface (front surface) 18B on the opposite side of the inner surface 18A. The heat radiator 29 is, for example, a heat sink or the like that includes a plurality of fin members protruding to the outside.

In the coil unit 10, the coil 13, the insulation member 14, and the core member 15 are sequentially laminated along the upward-downward direction and are arranged in the first accommodation portion 21 of the housing 11.

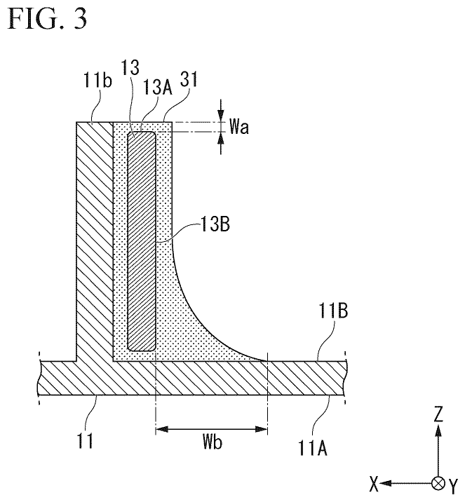

FIG. 3 is an enlarged view showing the coil 13 and the housing 11 in the coil unit 10 of the embodiment.

As shown in FIG. 3, the coil 13 is fixed, for example, to the heat release member 11b of the housing 11 via a support member 31. The support member 31 is formed of, for example, a predetermined material such as a resin having electrical insulation properties and thermal conductivity. The predetermined material is, for example, polyarylate (PAR), polyphenylene sulfide (PPS), polyurethane (PU), and the like. A dielectric breakdown voltage of the predetermined material is, for example, about 10 to 20 kV/mm. The thermal conductivity of the predetermined material is, for example, about 0.2 to 4 W/mK. The support member 31 is formed of a material such as a thermosetting resin, for example, by a process such as injection molding or so-called potting such as vacuum cast molding.

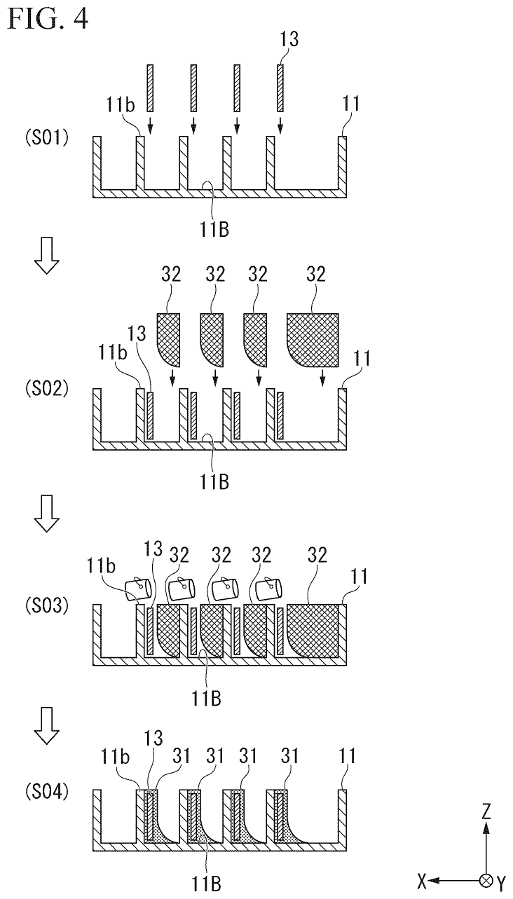

FIG. 4 is a view showing a process (potting process) of integrating the coil 13 and the housing 11 in the coil unit 10 of the embodiment.

As shown in FIG. 4, first, the coil 13 having a spiral shape is inserted between the plurality of heat release members 11b inside the housing 11 and is arranged so as to be separated by a predetermined distance from the inner surface 11B and each heat release member 11b (Step S01).

Next, a plurality of cores 32 are inserted between the plurality of heat release members 11b and are arranged so as to be separated by a predetermined distance from the coil 13 (Step S02). The shape of each core 32 is formed in accordance with the shape of the support member 31 described later.

Next, the material such as the thermosetting resin is injected into a space around the coil 13 formed of the inner surface 11B of the housing 11, each heat release member 11b, and each core 32 by so-called potting (Step S03).

Next, each core 32 is removed from the inside of the housing 11 after the support member 31 is formed by curing the material such as the thermosetting resin injected into the space around the coil 13 (Step S04).

As shown in FIG. 3, the outer shape of the support member 31 that covers the coil 13 is, for example, a shape in which, toward the inner surface 11B from a front end side of each heat release member 11b in a direction (Z-axis direction) along a direction (protrusion direction) in which each heat release member 11b protrudes from the inner surface 11B of the housing 11, a thickness in an orthogonal direction to the protrusion direction changes in an increasing tendency.

The outer shape of the support member 31 is, for example, a shape defined by a first thickness Wa and a second thickness Wb. The first thickness Wa is set, for example, in accordance with the electrical insulation properties of the support member 31 and is a thickness (for example, several mm or the like) required for ensuring the predetermined electrical insulation properties (for example, a dielectric strength voltage of several tens of kV or the like). The second thickness Wb is set, for example, in accordance with the thermal conductivity of the support member 31 and is a thickness required for ensuring the predetermined thermal conductivity (for example, a heat transfer amount or the like).

The first thickness Wa is, for example, a thickness of a portion that covers a front end surface 13A of the coil 13 on the front end side of the heat release member 11b in the direction (Z-axis direction) along the protrusion direction. The second thickness Wb is, for example, a thickness of a portion to an end of the support member 31 from a surface (end surface 13B) on the opposite side of the heat release member 11b side with respect to the coil 13 in the orthogonal direction (for example, the X-axis direction or the like) to the protrusion direction among portions that are in contact with the inner surface 11B of the housing 11, that is, a portion that covers the end surface 13B of the coil 13.

In the support member 31, the thickness of the portion between the coil 13 and the heat release member 11b and the thickness of the portion between the coil 13 and the inner surface 11B are, for example, a constant thickness such as the first thickness Wa.

In the support member 31, the thickness of the portion that covers the end surface 13B of the coil 13 in the orthogonal direction changes in an increasing tendency toward the second thickness Wb from the first thickness Wa or the like, for example, toward the inner surface 11B from the front end side of the heat release member 11b in the direction (Z-axis direction) along the protrusion direction.

As described above, according to the coil unit 10 of the embodiment, the width of the support member 31 in the orthogonal direction to the protrusion direction changes in an increasing tendency toward the inner surface 11B of the housing 11 from the front end side of the heat release member 11b along the protrusion direction, and thereby, it is possible to increase a heat transfer amount on the inner surface 11B side and improve cooling efficiency.

Since the second thickness Wb is set on the inner surface 11B side where the heat transfer amount is relatively large, for example, compared to the case where a constant thickness such as the second thickness Wb is set over the protrusion direction, it is possible to prevent an increase in weight and volume of the support member 31 while ensuring a desired thermal conductivity.

It is possible to ensure a desired withstand voltage and desired heat release properties by the support member 31 having the predetermined electrical insulation properties and the predetermined thermal conductivity with respect to the coil 13 that generates heat.

It is possible to ensure the desired withstand voltage and the desired heat release properties while preventing the increase in the weight and the volume of the support member 31.

It is possible to cool the coil 13 from the front surface 11A of the housing 11 by the groove 11a that efficiently guides the travel wind at the time of traveling of the vehicle. The coil 13 is in contact with the housing 11 via the support member 31 and thereby reduces thermal resistance, and it is possible to improve the cooling efficiency.

### Modification Example

The above embodiment is described using an example in which the support member 31 is formed by vacuum cast molding using a thermosetting resin as a material; however, the embodiment is not limited thereto. The support member 31 may be formed, for example, by another process such as injection molding and of another material other than the thermosetting resin.

The embodiments of the present invention have been presented as examples and are not intended to limit the scope of the invention. The embodiments can be implemented in a variety of other modes, and various omissions, substitutions, and modifications can be made without departing from the scope of the invention. The embodiments and modifications thereof are included within the scope and gist of the invention and are also included within the scope of the invention described in the appended claims and equivalents thereof.

What is claimed is:

1. A coil unit, comprising:
a housing having a front surface exposed to an outside below a vehicle body;
a heat release member that protrudes to an inside from an inner surface on a rear side with respect to the front surface of the housing;
a coil that is arranged within the housing and receives AC electric power transmitted in a contactless manner from an electric power transmission apparatus; and
a support member that is in contact with the inner surface of the housing and the heat release member and covers at least part of a surface of the coil,
wherein a width of the support member in an orthogonal direction to a protrusion direction of the heat release member changes in an increasing tendency toward the inner surface from a front end side of the heat release member along the protrusion direction.

2. The coil unit according to claim 1,
wherein the support member is formed of a material having a predetermined electrical insulation property and predetermined thermal conductivity.

3. The coil unit according to claim 2,
wherein a thickness of the support member that covers a front end surface of the coil in the protrusion direction is set in accordance with the electrical insulation property, and
a thickness of the support member that covers a surface on an opposite side of the heat release member side with respect to the coil in the orthogonal direction is set in accordance with the thermal conductivity.

4. The coil unit according to claim 1,
wherein the housing comprises the front surface in which a groove along a flow direction of wind received at a time of traveling is formed.

5. The coil unit according to claim 2,
wherein the housing comprises the front surface in which a groove along a flow direction of wind received at a time of traveling is formed.

6. The coil unit according to claim 3,
wherein the housing comprises the front surface in which a groove along a flow direction of wind received at a time of traveling is formed.
